(19) United States
(12) Patent Application Publication
(10) Pub. No.: US 2017/0246607 A1
(43) Pub. Date: Aug. 31, 2017

(54) Apparatus for Production of Pulverulent Poly(Meth)Acrylate

(71) Applicant: BASF SE, Ludwigshafen (DE)

(72) Inventors: Andreas Daiss, Ludwigshafen (DE); Robert Bayer, Sinsheim (DE); Rudolf Schliwa, Alzenau (DE); Jürgen Freiberg, Lampertheim (DE); Karl J. Possemiers, 'S Gravenwezel (BE); Marco Krüger, Mannheim (DE)

(73) Assignee: BASF SE, Ludwigshafen (DE)

(21) Appl. No.: 15/320,773

(22) PCT Filed: Jun. 10, 2015
(86) PCT No.: PCT/EP2015/062895

§ 371 Date: Dec. 21, 2016

(30) Foreign Application Priority Data
Jun. 23, 2014 (EP) 14173487.1

(51) Int. Cl. B01J 8/18; C08F 120/14; B01J 8/24

(52) U.S. Cl. CPC B01J 8/1872; B01J 8/24; C08F 120/14; B01J 2208/00893

(57) ABSTRACT

An apparatus for production of pulverulent poly(meth)acrylate, comprising a reactor or droplet polymerization, having an apparatus for dropletization of a monomer solution for the production of the poly(meth)acrylate, having holes through which the solution is dropletized, an addition point for a gas above the apparatus for dropletization, at least one gas withdrawal point on the periphery of the reactor and a fluidized bed. The outermost holes through which the solution is dropletized are positioned such that a droplet falling vertically downward falls into the fluidized bed and the hydraulic diameter at the level of the midpoint between the apparatus for dropletization and the gas withdrawal point is at least 10% greater than the hydraulic diameter of the fluidized bed.

The invention relates to an apparatus for production of pulverulent poly(meth)acrylate, comprising a reactor for droplet polymerization, having an apparatus for dropletization of a monomer solution for the production of the poly(meth)acrylate, having holes through which the solution is dropletized, an addition point for a gas above the apparatus for dropletization, at least one gas withdrawal point on the periphery of the reactor and a fluidized bed.

Poly(meth)acrylates find use especially as water-absorbing polymers which are used, for example, in the production of diapers, tampons, sanitary napkins and other hygiene articles, or else as water-retaining agents in market gardening.

The properties of the water-absorbing polymers can be adjusted via the level of crosslinking. With increasing level of crosslinking, there is a rise in gel strength and a fall in absorption capacity. This means that centrifuge retention capacity decreases with rising absorption under pressure, and the absorption under pressure also decreases again at very high levels of crosslinking.

To improve the performance properties, for example liquid conductivity in the diaper and absorption under pressure, water-absorbing polymer particles are generally postcrosslinked. This only increases the level of crosslinking at the particle surface, and in this way it is possible to at least partly decouple absorption under pressure and centrifuge retention capacity. This postcrosslinking can be performed in aqueous gel phase. In general, however, ground and sieved polymer particles are surface coated with a postcrosslinker, thermally postcrosslinked and dried. Crosslinkers suitable for this purpose are compounds which comprise at least two groups which can form covalent bonds with the carboxylate groups of the hydrophilic polymer.

Different processes are known for production of the water-absorbing polymer particles. For example, the monomers and any additives used for production of poly(meth)acrylates can be added to a mixing kneader, in which the monomers react to give the polymer. Rotating shafts with kneading bars in the mixing kneader break up the polymer formed into chunks. The polymer withdrawn from the kneader is dried and ground and sent to further processing. In an alternative variant, the monomer is introduced in the form of a monomer solution which may also comprise further additives into a reactor for droplet polymerization. On introduction of the monomer solution into the reactor, it breaks down into droplets. The mechanism of droplet formation may be turbulent or laminar jet disintegration, or else dropletization. The mechanism of droplet formation depends on the entry conditions and the physical properties of the monomer solution. The droplets fall downward in the reactor, in the course of which the monomer reacts to give the polymer. In the lower region of the reactor is a fluidized bed into which the polymer particles formed from the droplets by the reaction fall. Further reaction then takes place in the fluidized bed. Corresponding processes are described, for example, in WO-A 2006/079631, WO-A 2008/086976, WO-A 2007/031441, WO-A 2008/040715, WO-A 2010/003855 and WO-A 2011/026876.

A disadvantage of all the processes that are conducted by the principle of droplet polymerization, in which monomer solution disintegrates into droplets and falls downward in a reactor to form the polymer, is that droplets can coalesce on collision, and droplets hitting the wall of the reactor can also stick and thus lead to unwanted formation of deposits. Moreover, an increase in the size of the fluidized bed is necessary in the case of scale-up to the industrial scale, which leads to a significant increase in energy consumption.

It is therefore an object of the present invention to provide a reactor for droplet polymerization in which formation of deposits as a result of droplets hitting the walls is minimized, and in which, in addition, the energy requirement can be minimized on the industrial scale.

The object is achieved by an apparatus for production of pulverulent poly(meth)acrylate, comprising a reactor for droplet polymerization, having an apparatus for dropletization of a monomer solution for the production of the poly(meth)acrylate, having holes through which the solution is dropletized, an addition point for a gas above the apparatus for dropletization, at least one gas withdrawal point on the periphery of the reactor and a fluidized bed, wherein the outermost holes through which the solution is dropletized are positioned such that a droplet falling vertically downward falls into the fluidized bed and the hydraulic diameter at the level of the midpoint between the apparatus for dropletization and the gas withdrawal point is at least 10% greater than the hydraulic diameter of the fluidized bed.

Through the configuration of the reactor for droplet polymerization such that the hydraulic diameter at the level of the midpoint between the apparatus for dropletization and the gas withdrawal point is at least 10% greater than the hydraulic diameter of the fluidized bed, it is ensured that only a small portion of the droplets reaches the wall, and this only occurs after a residence time at which the droplets are no longer tacky. Furthermore, by virtue of the outermost holes through which the solution is dropletized being positioned such that a droplet falling vertically downward falls into the fluidized bed, droplets are prevented from hitting the wall and adhering thereon, which results in formation of a deposit.

The hydraulic diameter dₕ is calculated to be:

dₕ=4·A/C

where A is the area and C is the circumference. By virtue of the use of the hydraulic diameter, the configuration of the reactor is independent of the shape of the cross-sectional area. This area may, for example, be circular, rectangular, in the form of any polygon, oval or elliptical. Preference is given, however, to a circular cross-sectional area.

In order that the monomer solution leaving the apparatus for dropletization is not sprayed onto the wall of the reactor, and in order at the same time to configure the reactor advantageously both in static terms and in terms of material expenditure, it is preferable to form the head of the reactor in the shape of a frustocone and to position the apparatus for dropletization in the frustoconical head of the reactor.

The frustoconical configuration of the head of the reactor can save material compared to a cylindrical configuration. Moreover, a frustoconical head serves to improve the structural stability of the reactor. A further advantage is that the gas which is introduced at the head of the reactor has to be supplied through a small cross section and subsequently flows downward in the reactor without significant vortexing because of the frustoconical configuration. The vortexing which can be established in the case of a cylindrical configuration of the reactor in the head region and a gas feed in the middle of the reactor has the disadvantage that droplets that are entrained with the gas flow can be transported against the wall of the reactor because of the vortexing and hence can contribute to formation of deposits.

In order to keep the height of the reactor as low as possible, it is also advantageous when the apparatus for dropletization of the monomer solution is disposed as far upward as possible in the frustoconical head. This means that the apparatus for dropletization of the monomer solution is disposed at the level in the frustoconical head at which the diameter of the frustoconical head corresponds roughly to the diameter of the apparatus for dropletization.

In order to prevent the monomer solution which leaves the apparatus for dropletization in the region of the outermost holes from being sprayed against the wall of the frustoconical head, it is particularly preferable when the hydraulic diameter of the frustoconical head, at the level at which the apparatus for dropletization is disposed, is 2% to 30%, more preferably 4% to 25% and especially 5% to 20% greater than the hydraulic diameter corresponding to the area which is enclosed by a line connecting the outermost holes. The somewhat greater hydraulic diameter of the head additionally ensures that droplets, even below the reactor head, do not prematurely hit the reactor wall and adhere thereon.

In a further-preferred embodiment, the reactor widens conically above the fluidized bed to its maximum hydraulic diameter. The conical widening has the advantage that polymer particles which have formed from the droplets through polymerization of the monomer solution during their fall can fall into the fluidized bed without being sucked out of the reactor together with the offgas. Polymer particles which hit the conical widening directly can slide into the fluidized bed with support by suitable tappers on the outside of the conical part of the reactor.

Through the addition point for gas above the apparatus for dropletization of the monomer solution, gas and droplets flow through the reactor from the top downward in cocurrent. Since the fluidized bed is in the lower region of the reactor, the effect of this is that gas flows from the bottom upward in the opposite direction in the lower region of the reactor. Since gas is introduced into the reactor at both from the top and from the bottom, it is necessary to withdraw the gas between the apparatus for dropletization of the monomer solution and the fluidized bed. Preferably, the gas withdrawal point is positioned at the transition from the conical widening above the fluidized bed to the cylindrical wall of the reactor. The corresponding widening in the cross section to the maximum reactor diameter at the level of the gas withdrawal point prevents particle entrainment into the reactor offgas. The cross-sectional area of the gas withdrawal ring is sufficiently large that the mean gas velocity in the ring is 0.25 to 3 m/s, preferably 0.5 to 2.5 m/s and especially 1.0 to 1.8 m/s. Smaller values do reduce particle entrainment, but lead to uneconomically large dimensions; greater values lead to an undesirably high particle entrainment.

The region of the reactor where the gas withdrawal point is positioned is preferably configured such that the diameter of the conical widening is greater at the upper end thereof than the diameter of the upper section of the reactor. The gas flowing through the reactor from the top flows around the lower end of the reactor wall of the upper section and is withdrawn via at least one gas draw point from the annular space formed between the upper end of the conical widening and the lower end of the reactor wall that projects into the conical widening. Connected to the gas draw point is an apparatus for separation of solids, in which polymer particles which are drawn off from the reactor with the gas flow can be separated off. Suitable apparatuses for separating solids are, for example, filters or centrifugal separators, for example cyclones. Particular preference is given to cyclones.

According to the invention, the hydraulic diameter of the fluidized bed is selected such that the area of the fluidized bed is at least sufficiently large that a droplet falling vertically downward from the outermost holes of the apparatus for dropletization falls into the fluidized bed. For this purpose, the area of the fluidized bed is at least just as large as and/or just the same shape as the area which is formed by a line connecting the outermost holes of the apparatus for dropletization. In addition, it is also possible that the surface of the fluidized bed is larger than the area which is formed by the line connecting the outermost holes of the apparatus for dropletization. It is particularly preferable when the surface area of the fluidized bed is 5% to 50%, more preferably 10% to 40% and especially 15% to 35% greater than the area formed by the line connecting the outermost holes of the apparatus for dropletization. In this case, the shape of the surface of the fluidized bed corresponds in each case to the shape of the area which is enclosed by the line connecting the outermost holes. If, for example, the surface of the fluidized bed is circular, the area enclosed by the line connecting the outermost holes is also circular, in which case the diameter of the surface of the fluidized bed may be greater than the diameter of the area which is formed by the line connecting the outermost holes of the apparatus for dropletization.

Typically, the monomer solution exits from the holes of the apparatus for dropletization in the form of a liquid jet which then disintegrates into droplets in the reactor. The disintegration of the liquid jet depends firstly on the amount of the liquid which exits through the holes per unit time, and secondly on the velocity and the volume of the gas flowing through the reactor. In addition, the physical properties of the monomer solution and the geometry of the holes affect the way in which the jet disintegrates. In the context of present invention, droplet disintegration is also referred to as dropletization.

In order that enough gas can flow past the apparatus for dropletization of the monomer solution, so that a homogeneous gas velocity in the reactor can be achieved and there is not excessive acceleration and vortexing of the gas as it flows round the apparatus, it is additionally preferable that the ratio of the area covered by the apparatus for dropletization in the reactor relative to the area which is enclosed by the line connecting the outermost holes is less than 50% and is preferably in the range between 3% and 30%.

It is additionally preferable when the number of holes relative to the area which is formed by the line connecting the outermost holes is in the range from 100 to 1000 holes/m², preferably in the range from 150 to 800 holes/m² and especially in the range from 200 to 500 holes/m². This ensures that the droplets formed at the holes have a sufficiently large separation and can additionally come into sufficient contact with the gas flowing through the reactor.

In one embodiment, the apparatus for dropletization of the monomer solution comprises channels, with the holes formed at the base thereof, and arranged in a star shape. The star-shaped arrangement of the channels, especially in a reactor with circular cross section, enables homogeneous distribution of the droplets in the reactor. The addition is effected through the channels into which the monomer solution is introduced. The liquid exits through the holes at the base of the channels and forms the droplets.

In order that the droplets exiting from the channels come into contact as quickly as possible with the gas flowing around the channels, it is additionally preferable when the channels have a minimum width. The width of the channels is preferably in the range from 25 to 500 mm, further preferably in the range from 100 to 400 mm and especially in the range from 150 to 350 mm.

The number N_{RL} of individual channels in the case of a star-shaped arrangement is dependent on the circumference C of the reactor at the position where the channels are arranged.

Preferably, the number of channels is within the range defined below:

$$\frac{C}{4.0 m} \leq {N}_{RL} \leq \frac{C}{1.2 m}$$

and especially

$$\frac{C}{3.6 m} \leq {N}_{RL} \leq \frac{C}{1.8 m}$$

In these formulae, the circumference C should be used in meters and “m” means meters. In addition to a configuration such that the channels of the apparatus for dropletization are arranged in a star shape, they may also be arranged in any desired arrangement with respect to one another, for example parallel to one another or overlapping one another, such that, for example, a rectangular pitch or a triangular pitch is achieved by the arrangement of the channels. In the case of a triangular pitch and a rectangular pitch, a plurality of channels aligned in parallel are aligned transverse to one another in each case, the angle between the channels aligned transverse to one another being 90° in the case of a rectangular pitch and preferably 60° in the case of a triangular pitch.

It is additionally preferable when at least the holes at the edge of the channel are formed in such a way that the monomer solution exits from the holes at an angle relative to the axis of the reactor. Through the exit of the monomer solution at an angle relative to the axis of the reactor, it is possible to obtain a more homogeneous distribution of the droplets in the reactor and a greater separation of the droplets from a channel from one another. In the case of a star-shaped arrangement of the channels, it is additionally preferable when the angle at which the monomer solution exits from the holes relative to the axis of the reactor increases from the inside outward. The exiting of the liquid at an angle relative to the axis of the reactor can be achieved either through appropriate configuration of the holes, for example by virtue of them being formed at an angle in the dropletizer plate, or alternatively through angled configuration of the dropletizer plate.

If the angle at which the droplets exit from the holes is constant over the entire length of the individual channels of the apparatus for dropletization, it is preferably in the range from 0 to 30°, preferably in the range from 0.1 to 20° and especially in the range from 0.2 to 15°.

Especially in the case of a star-shaped arrangement of the channels, it is preferable when the angle at which the droplets exit from the holes varies with the position of the hole, since the distance between two channels increases from the middle outward. Thus, it is advantageous when the angle closer to the middle is smaller than the angle at the outer holes.

In the case of a star-shaped arrangement, it is preferable when the angle α at which the liquid exits at least from the holes at the radial edges is within the range defined below:

$$\frac{r}{{N}_{LR} \cdot {d}_{P} \cdot {v}^{0.578}} \cdot ( 0.00697 \cdot r + 0.0332 ) - 6.296 \leq α \leq \frac{r}{{N}_{LR} \cdot {d}_{P} \cdot {v}^{0.578}} \cdot ( 0.00697 \cdot r + 0.0332 ) + 4.704 ,$$

preferably

$$\frac{r}{{N}_{LR} \cdot {d}_{P} \cdot {v}^{0.578}} \cdot ( 0.00697 \cdot r + 0.0332 ) - 4.296 \leq α \leq \frac{r}{{N}_{LR} \cdot {d}_{P} \cdot {v}^{0.578}} \cdot ( 0.00697 \cdot r + 0.0332 ) + 2.704$$

and more preferably

$$\frac{r}{{N}_{LR} \cdot {d}_{P} \cdot {v}^{0.578}} \cdot ( 0.00697 \cdot r + 0.0332 ) - 2.296 \leq α \leq \frac{r}{{N}_{LR} \cdot {d}_{P} \cdot {v}^{0.578}} \cdot ( 0.00697 \cdot r + 0.0332 ) + 1.704 ,$$

for the range of validity

$$0.25 m \leq r \leq 10 m$$

$$0.001 m \leq {d}_{ P} \leq 0.0015 m$$

$$3 \frac{m}{s} \leq v \leq 30 \frac{m}{s} \\ 3 \leq {N}_{LR} \leq 18.$$

In these formulae, r is the radial position of the hole in meters, N_{LR} is the number of channels, dₚ is the mean droplet diameter in meters and v is the droplet exit velocity in meters per second. The angle a of the holes is found in degrees. If a value less than zero is found, the value of 0° should be used for the angle in place of the value calculated.

The exit angle of the droplets relative to the axis of the reactor can be optimized further by numerical simulation calculations. As well as a constant change in the exit angle, it is alternatively also possible to change the exit angle of the droplets stepwise. For this purpose, in that case, the angle in the middle of each stage is preferably fixed according to the above definition.

For a simple revision of the apparatus for dropletization of the monomer solution, it is additionally preferable when the channel is connected at its base to at least one dropletizer plate in which the holes for addition of the monomer solution are formed. This firstly enables variation, for example, in the exit angle and/or in the size of the holes through exchange of the dropletizer plates in a simple manner as a function of the monomer solution or of the desired droplet size; secondly, it is also possible to exchange the dropletizer plates in a simple manner, in order, for example, to clean used dropletizer plates when they are soiled.

Exiting of the liquid from the holes of the dropletizer plates at an angle to the axis of the reactor can be achieved, for example, by virtue of the dropletizer plates being angled along their longitudinal axis at the base thereof. In the case of a star-shaped arrangement of the channels and hence of the dropletizer plates, the effect of this is that the liquid exits from the holes at an angle relative to a plane running through the axis of the reactor. The holes through which the monomer solution is added to the reactor are preferably arranged in rows parallel to the longitudinal axis of the dropletizer plate. The angle at which the dropletizer plates are aligned relative to the horizontal corresponds here to the exit angle of the droplets from the holes to the vertical axis of the reactor. Especially in the case of use of a plurality of dropletizer plates and a star-shaped arrangement of the channels, it is advantageous when, in the event of variation in the exit angle, each dropletizer plate in a channel has a different angle which increases from the inside outward and is determined in the middle of the dropletizer plate in each case by the above definition.

As well as an angled configuration of the dropletizer plates, any other configuration in which the holes of the dropletizer plates along the longitudinal axis are lower in the middle than at the edges is also possible. This is possible, for example, when the dropletizer plate is formed in the form of a circle segment along the longitudinal axis. It is also possible, for example, to configure the dropletizer plates such that it has, at the midpoint along the longitudinal axis, a region with a flat profile, and the lateral regions to the left and right of the flat region are angled toward the longitudinal axis or are configured in the form of an arc.

In order to produce a sufficiently large number of droplets, it is preferable when the holes in the dropletizer plates are arranged in several rows of holes. It is especially preferable here when the distance between the individual holes in a row of holes and the distance between adjacent rows of holes are essentially the same. A suitable distance between the holes in a row of holes and of the rows of holes from one another is in the range from 1 to 100 mm, preferably in the range from 2 to 50 mm and especially in the range from 3 to 20 mm.

In order to obtain droplets of a suitable size for water-absorbing polymers, it is additionally preferable when the holes in the dropletizer plates have a diameter in the range from 25 to 500 μm.

Working examples of the invention are shown in the figures and are more particularly described in the description which follows.

The figures show:

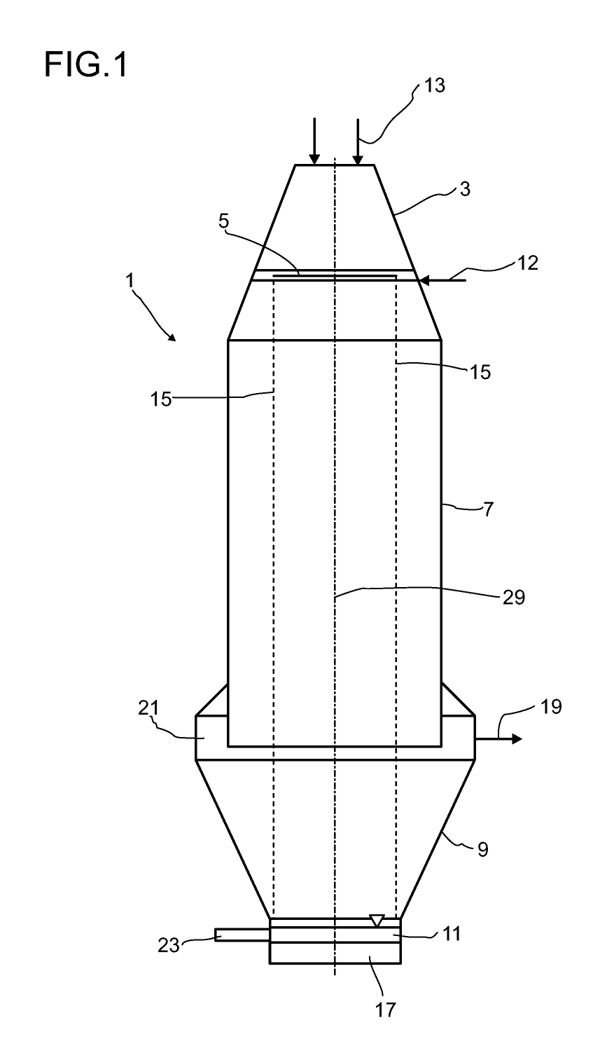

FIG. 1 a longitudinal section through a reactor for droplet polymerization,

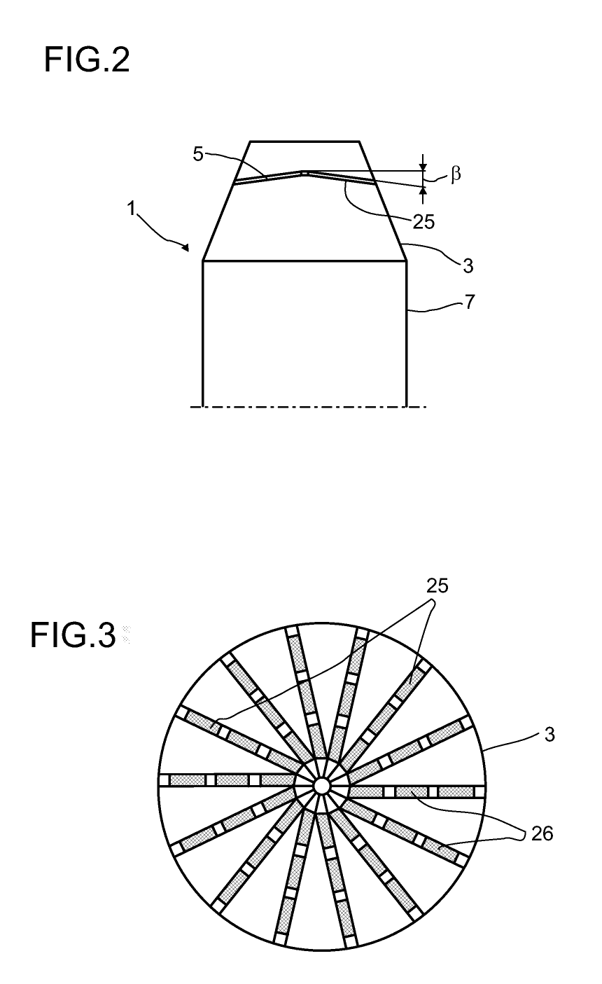

FIG. 2 a longitudinal section through the reactor head,

FIG. 3 an arrangement of dropletizer channels in a first embodiment,

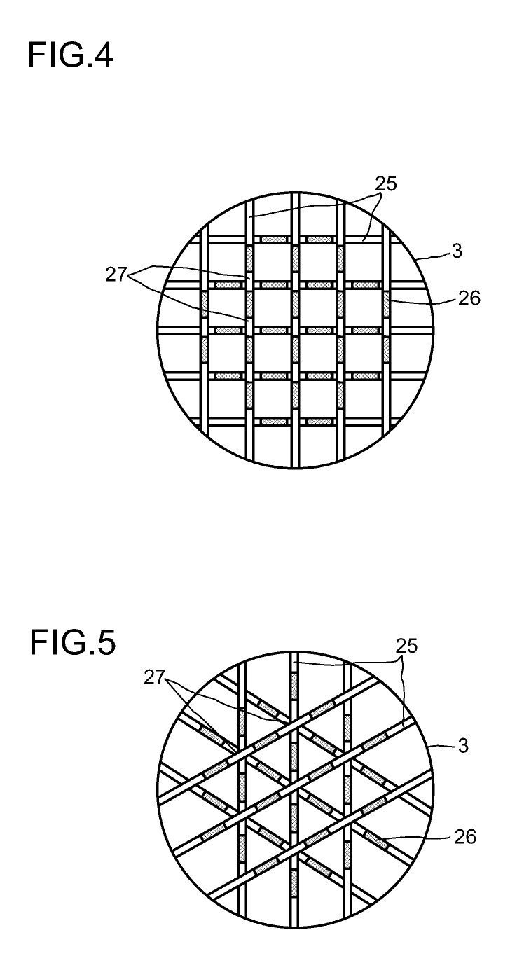

FIG. 4 an arrangement of dropletizer channels in a second embodiment,

FIG. 5 an arrangement of dropletizer channels in a third embodiment,

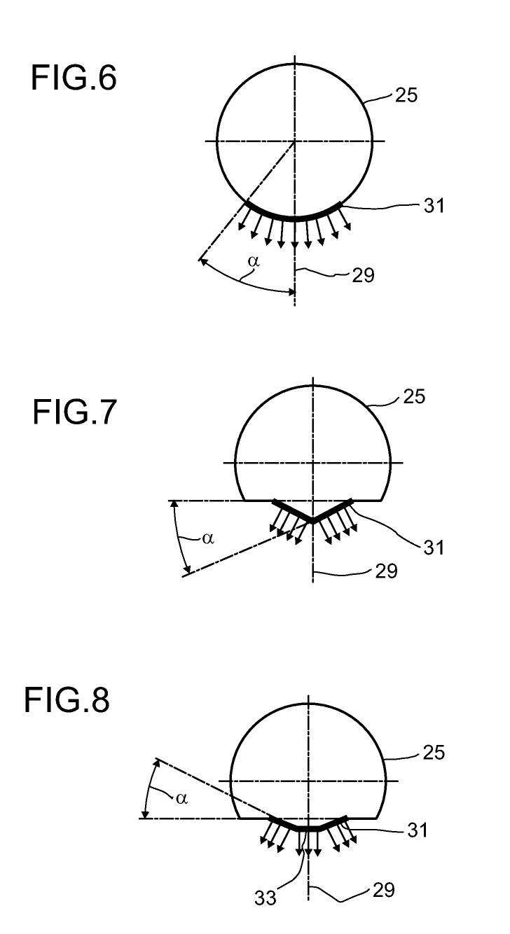

FIG. 6 a cross section through a dropletizer channel in a first embodiment,

FIG. 7 a cross section through a dropletizer channel in a second embodiment,

FIG. 8 a cross section through a dropletizer channel in a third embodiment.

FIG. 1 shows a longitudinal section through a reactor configured in accordance with the invention.

A reactor 1 for droplet polymerization comprises a reactor head 3 in which there is accommodated an apparatus for dropletization 5, a middle region 7 in which the polymerization reaction proceeds, and a lower region 9 having a fluidized bed 11 in which the reaction is concluded.

For performance of the polymerization reaction to prepare the poly(meth)acrylate, the apparatus for dropletization 5 is supplied with a monomer solution via a monomer feed 12. When the apparatus for dropletization 5 has a plurality of channels, it is preferable to supply each channel with the monomer solution via a dedicated monomer feed 12. The monomer solution exits through holes, which are not shown in FIG. 1, in the apparatus for dropletization 5 and disintegrates into individual droplets which fall downward within the reactor. Through a first addition point for a gas 13 above the apparatus for dropletization 5, a gas, for example nitrogen or air, is introduced into the reactor 1. This gas flow supports the disintegration of the monomer solution exiting from the holes of the apparatus for dropletization 5 into individual droplets. In addition, the gas flow promotes lack of contact of the individual droplets and coalescence thereof to larger droplets.

In order firstly to make the cylindrical middle region 7 of the reactor very short and additionally to avoid droplets hitting the wall of the reactor 1, the reactor head 3 is preferably conical, as shown here, in which case the apparatus for dropletization 5 is within the conical reactor head 3 above the cylindrical region. Alternatively, however, it is also possible to make the reactor cylindrical in the reactor head 3 as well, with a diameter as in the middle region 7. Preference is given, however, to a conical configuration of the reactor head 3. The position of the apparatus for dropletization 5 is selected such that there is still a sufficiently large distance between the outermost holes through which the monomer solution is supplied and the wall of the reactor to prevent the droplets from hitting the wall. For this purpose, the distance should at least be in the range from 50 to 1500 mm, preferably in the range from 100 to 1250 mm and especially in the range from 200 to 750 mm. It will be appreciated that a greater distance from the wall of the reactor is also possible. This has the disadvantage, however, that a greater distance is associated with poorer exploitation of the reactor cross section.

The lower region 9 concludes with a fluidized bed 11, into which the polymer particles formed from the monomer droplets fall during the fall. In the fluidized bed, further reaction proceeds to give the desired product. According to the invention, the outermost holes through which the monomer solution is dropletized are positioned such that a droplet falling vertically downward falls into the fluidized bed 11. This can be achieved, for example, by virtue of the hydraulic diameter of the fluidized bed being at least as large as the hydraulic diameter of the area which is enclosed by a line connecting the outermost holes in the apparatus for dropletization 5, the cross-sectional area of the fluidized bed and the area formed by the line connecting the outermost holes having the same shape and the centers of the two areas being at the same position in a vertical projection of one onto the other. The outermost position of the outer holes relative to the position of the fluidized bed 11 is shown in FIG. 1 with the aid of a dotted line 15.

In order, in addition, to avoid droplets hitting the wall of the reactor in the middle region 7 as well, the hydraulic diameter at the level of the midpoint between the apparatus for dropletization and the gas withdrawal point is at least 10% greater than the hydraulic diameter of the fluidized bed.

The reactor 1 may have any desired cross-sectional shape. However, the cross section of the reactor 1 is preferably circular. In this case, the hydraulic diameter corresponds to the diameter of the reactor 1.

Above the fluidized bed 11, the diameter of the reactor 1 increases in the embodiment shown here, such that the reactor 1 widens conically from the bottom upward in the lower region 9. This has the advantage that polymer particles formed in the reactor 1 that hit the wall can slide downward into the fluidized bed 11 along the wall. To avoid caking, it is additionally possible to provide tappers, not shown here, on the outside of the conical section of the reactor, with which the wall of the reactor is set in vibration, as a result of which adhering polymer particles are detached and slide into the fluidized bed 11.

For gas supply for the operation of the fluidized bed 11, a gas distributor 17 present beneath the fluidized bed 11 blows the gas into the fluidized bed 11.

Since gas is introduced into the reactor 1 both from the top and from the bottom, it is necessary to withdraw gas from the reactor 1 at a suitable position. For this purpose, at least one gas withdrawal point 19 is disposed at the transition from the middle region 7 having constant cross section to the lower region 9 which widens conically from the bottom upward. In this case, the wall of the cylindrical middle region 7 projects into the lower region 9 which widens conically in the upward direction, the diameter of the conical lower region 9 at this position being greater than the diameter of the middle region 7. In this way, an annular chamber 21 which surrounds the wall of the middle region 7 is formed, into which the gas flows and can be drawn off through the at least one gas withdrawal point 19 connected to the annular chamber 21.

The further-reacted polymer particles of the fluidized bed 11 are withdrawn by a product withdrawal point 23 in the region of the fluidized bed.

FIG. 2 shows a longitudinal section through the reactor head.

In the embodiment shown here, the reactor head 3 is conical. The apparatus for dropletization 5 comprises individual channels 25 which project into the reactor 3 in a star shape from the outside to the middle of the reactor head 3. In order to promote lack of impact of the droplets leaving the apparatus for dropletization 5 with the wall of the reactor 1, the channels in the embodiment shown here are arranged in the reactor head 3 at an angle 13 to the horizontal. The angle β is preferably in the range from 0° to 20°, more preferably in the range from 0° to 15°, especially preferably in the range from 0° to 10° and especially in the range from 0° to 5°. By virtue of the corresponding alignment of the channels, the droplets exit from the channels at an angle pointing toward the middle of the reactor, such that the risk of droplets being able to arrive at the wall of the reactor 1 and cake thereon is minimized further.

A corresponding star-shaped arrangement of the channels 25 is shown in FIG. 3. Further possible arrangements of the channels are shown in FIGS. 4 and 5. In these, however, an arrangement with an angle β to the horizontal can be achieved only with difficulty, such that the channels 25 in this case preferably run horizontally. FIG. 4 shows an arrangement in rectangular pitch, in which the individual channels 25 each arranged at an angle of 90° to one another, such that the points of intersection 27 of the channels each form rectangles, preferably squares.

FIG. 5 shows an arrangement in triangular pitch. The channels 25 here are each arranged at an angle of 60° relative to one another, such that the points of intersection 27 of the channels 25 each form equilateral triangles. However, this additionally requires the channels that run parallel in each case always to have an equal separation.

As an alternative to the embodiments shown here, it is of course also possible to arrange the channels such that the distance between channels arranged in parallel varies, or the distance between the channels arranged in parallel is equal in each case but the distances between the channels that are arranged in parallel and run in different directions are different. In addition, it is also possible to arrange the channels at any other angle relative to one another.

Especially in the case of a circular reactor cross section, however, the star-shaped arrangement shown in FIG. 3 is preferred. In this case, however, the number of channels may vary as a function of the circumference of the reactor. In addition, it is possible to configure the channels with different lengths, such that they project into the reactor 1 to different extents. However, a rotationally symmetrical arrangement is always preferred.

The position of dropletizer plates 26 which conclude the channels for supply of the monomer solution at the base thereof, and in which the holes through which the monomer solution is dropletized into the reactor are formed, is shown in FIGS. 3 to 5 by the dotted areas.

FIGS. 6, 7 and 8 show cross sections through the channels 25 in different embodiments.

In order to obtain a homogeneous droplet distribution over the reactor cross section, it is preferable when at least the droplets that are formed in a channel in the outer holes exit at an angle to the vertical, i.e. to the reactor axis. For this purpose, it is possible, for example, to configure the region of the channel in which the holes are formed, as shown in FIG. 6, in the form of a circle segment. As a result of this, the angle a at which the monomer solution exits in relation to the reactor axis 29 increases from the middle of the channel outward.

Alternatively, it is also possible, as shown in FIG. 7, to align the channel base in which the holes are formed at an angle to the horizontal, in which case, for holes at right angles to the channel base 31, the angle a at which the droplets exit relative to the reactor axis corresponds to the angle a of the channel base to the horizontal. Another possibility is a configuration in which, in addition to the angled regions of the channel base 31, a middle base region 33 runs horizontally.

In order to enable simple cleaning of the holes, it is advantageous when the holes are formed in dropletizer plates which are positioned at correspondingly configured orifices in the base of the channels 25. The dropletizer plates can then be deinstalled for cleaning and replaced by clean dropletizer plates. In this case, the dropletizer plates are preferably configured either in the form of a circle segment or in angled form, in order that a base profile of the channel 25 as shown in FIGS. 6 to 8 can be achieved.

Especially in the case of a star-shaped arrangement of the channels, it is additionally preferable when the angle at which the monomer solution exits increases from the middle of the reactor outward.

As well as the circular cross section shown here, it is also possible to configure the channels 25 with any other cross section. Especially when dropletizer plates are used, it is particularly preferable to form the channels 25 with a rectangular cross section. In this case, the channel may be sealed at the top by a removable lid, and the dropletizer plates may be removed and exchanged in a simple manner after removal of the lid.

### LIST OF REFERENCE NUMERALS

1 reactor
3 reactor head
5 apparatus for dropletization
7 middle region
9 lower region
11 fluidized bed
12 monomer feed
13 addition point for gas
15 position of the outermost holes in relation to the fluidized bed 11
17 gas distributor
19 gas withdrawal point
21 annular chamber
23 product withdrawal point
25 channel
26 dropletizer plate
27 point of intersection
29 reactor axis
31 channel base
33 middle region of base

1. An apparatus for production of pulverulent poly(meth)acrylate, comprising a reactor (1) for droplet polymerization, having an apparatus for dropletization (5) of a monomer solution for the production of the poly(meth)acrylate, having holes through which the solution is dropletized, an addition point for a gas (13) above the apparatus for dropletization (5), at least one gas withdrawal point (19) on the periphery of the reactor (1) and a fluidized bed (11), wherein the outermost holes through which the solution is dropletized are positioned such that a droplet falling vertically downward falls into the fluidized bed (11) and the hydraulic diameter at the level of the midpoint between the apparatus for dropletization (5) and the gas withdrawal point (19) is at least 10% greater than the hydraulic diameter of the fluidized bed (11), wherein the reactor (1) widens conically above the fluidized bed (11) to its maximum hydraulic diameter and the at least one gas withdrawal point (19) is positioned at the transition from the conical widening above the fluidized bed (11) to the cylindrical wall of the reactor (1), wherein at the upper end of the widening the diameter of the conical widening above the fluidized bed (11) is greater than the diameter of the reactor wall above the conical widening, wherein the reactor wall projects into the conical widening so as to form an annular gap in which the gas withdrawal point is positioned between the conical widening and the reactor wall.

2. The apparatus according to claim 1, wherein the head (3) of the reactor (1) takes the form of a frustocone and the apparatus for dropletization (5) is positioned in the frustoconical head (3) of the reactor (1).

3. The apparatus according to claim 1 or 2, wherein the ratio of the area in the reactor (1) covered by the apparatus for dropletization (5) relative to the area enclosed by a line connecting the outermost holes is less than 50%.

4. The apparatus according to claim 1, wherein the apparatus for dropletization (5) of the monomer solution has channels (25) arranged in a star shape, with the holes formed at the base thereof.

5. The apparatus according to claim 4, wherein at least the holes at the edge of the channel (25) are formed in such a way that the monomer solution exits from the holes at an angle relative to the axis (29) of the reactor (1).

6. The apparatus according to claim 4, wherein the channel (25) is connected at its base to at least one dropletizer plate in which the holes for addition of the monomer solution are formed.

7. The apparatus according to claim 6, wherein the dropletizer plates are angled along their longitudinal axis at the base thereof.

8. The apparatus according to claim 6, wherein the holes of the dropletizer plates along the longitudinal axis are lower in the middle than at the edges.

9. The apparatus according to claim 6, wherein the holes of the dropletizer plates are arranged in a plurality of rows of holes.

10. The apparatus according to claim 1, wherein the holes in the dropletizer plates have a diameter in the range from 25 to 500 μm.

11. (canceled)

12. (canceled)

13. (Cancellled)

14. The apparatus according to claim 5, wherein the channel (25) is connected at its base to at least one dropletizer plate in which the holes for addition of the monomer solution are formed.

15. The apparatus according to claim 7, wherein the dropletizer plates are angled along their longitudinal axis at the base thereof.

16. The apparatus according to claim 7, wherein the holes of the dropletizer plates are arranged in a plurality of rows of holes.

17. The apparatus according to claim 8, wherein the holes of the dropletizer plates are arranged in a plurality of rows of holes.
